(19) United States
(12) Patent Application Publication
(10) Pub. No.: US 2026/0228793 A1
(43) Pub. Date: Aug. 6, 2026

(54) SYSTEMS AND METHODS OF METADATA ABSTRACTION AND COMPARISON

(71) Applicant: Walmart Apollo, LLC, Bentonville, AR (US)

(72) Inventors: Reza Yousefi Maragheh, Los Altos, CA (US); Charan Chand Irugu, Milpitas, CA (US); Chenhao Fang, San Jose, CA (US); Aysenur Inan, Mountain View, CA (US); Ramin Giahi, Los Altos, CA (US); Jianpeng Xu, Cupertino, CA (US); Parth Hetal Parikh, Minneapolis, MN (US); Hyun Duk Cho, San Francisco, CA (US); Saranyan Sukumar, Pleasanton, CA (US); Malay Kumar Patel, Fremont, CA (US); Sushant Kumar, San Jose, CA (US); Evren Korpeoglu, San Jose, CA (US); Kannan Achan, Saratoga, CA (US); Jayesh Uddhav Kudase, Santa Clara, CA (US)

(21) Appl. No.: 19/042,374

(22) Filed: Jan. 31, 2025

(51) Int. Cl. G06Q 30/0601

(52) U.S. Cl. CPC G06Q 30/0629

(57) ABSTRACT

Some embodiments provide systems to provide metadata abstraction for a comparison interface. An example system includes a non-transitory machine-readable medium storing instructions that, when executed by a processing resource, may cause the resource to: compile textual metadata associated with an item, determine a ranked list of use cases for the item based in part on using one or more prompts to a language model, at least one of the one or more prompts includes the textual metadata, receive, via a client interface provided to a client device, a selection of the item and a comparison item; and select a highlighted use case to display with the item in a comparison interface of the client interface, wherein the highlighted use case is selected based on the ranked list associated with the item and a ranked list of use cases associated with the comparison item in the use case database.

### TECHNICAL FIELD

This disclosure relates generally to metadata abstraction and comparison.

### BACKGROUND

Management and presentation of a large number of data items can significantly affect client-side interaction experience and decision-making. In databases tracking physical objects, for example, each object may have dozens or hundreds of metadata representing various attributes making a meaningful and comprehensive comparison of data items difficult.

### BRIEF DESCRIPTION OF DRAWINGS

Disclosed herein are embodiments of systems, apparatuses and methods pertaining to metadata abstraction. This description includes drawings, wherein:

FIG. 1 illustrates a block diagram of an example backend system that provides metadata abstraction and a comparison interface, in accordance with some embodiments.

FIG. 2 illustrates a flow diagram of an example process for providing metadata abstraction and a comparison interface, in accordance with some embodiments.

FIG. 3 depicts an example system that includes one or more non-transitory, machine readable media encoded with example instructions executable by one or more processing resources, in accordance with some embodiments.

FIG. 4 illustrates a flow diagram of an example process for performing metadata abstraction, in accordance with some embodiments.

FIG. 5 depicts an example system that includes one or more non-transitory, machine readable media encoded with example instructions executable by one or more processing resources, in accordance with some embodiments.

FIGS. 6, 7A, and 7B illustrate example client interface displays, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in but is not limited to at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

The comparison and management of a large volume of data items are important to user experience and decision-making. A multi-agent approach utilizing language models (LMs) such as Large Language Models (LLMS) is described herein to provide metadata abstraction for a comparison client interface. For example, in the context of an e-commerce site, metadata abstraction can provide use case comparisons between items selected for comparison to augment a comparison interface. Abstraction can further provide keywords and descriptions relevant to a given use case to supplement the static description of the item. Generally, an agent is a software entity that interacts with a machine learning model or a programming language, serving as an intermediary between the model and other components of a system. This agent acts as a go-between, generating inputs for the model, and then translating the model's outputs into responses that are meaningful within the specific context of the application. In some instances, agents can autonomously access local and external resources such as databases and third party services to modify its interactions with a machine learning model to affect the outcome.

The present disclosure describes a multi-agent approach that improves the outcome of machine learning model abstractions to provide a context-aware description abstracted from a collection of attributes to augment comparison client interfaces. Unlike traditional methods that rely on static metadata, the multi-agent approach dynamically generates metadata abstractions using LMs. This results in more relevant and context-aware descriptions, improving the user experience by providing more meaningful comparisons. The use of multiple agents to verify the outputs of LMs ensures higher accuracy and reliability, which is a significant improvement over prior art where single LM queries may produce less accurate results due to the lack of cross-verification. Additionally, the system generates context-aware descriptions by abstracting a collection of attributes, tailoring the information to the user's needs and enhancing decision-making processes. The dynamic generation of keywords and descriptions relevant to specific use cases provides users with a more comprehensive understanding of the items being compared.

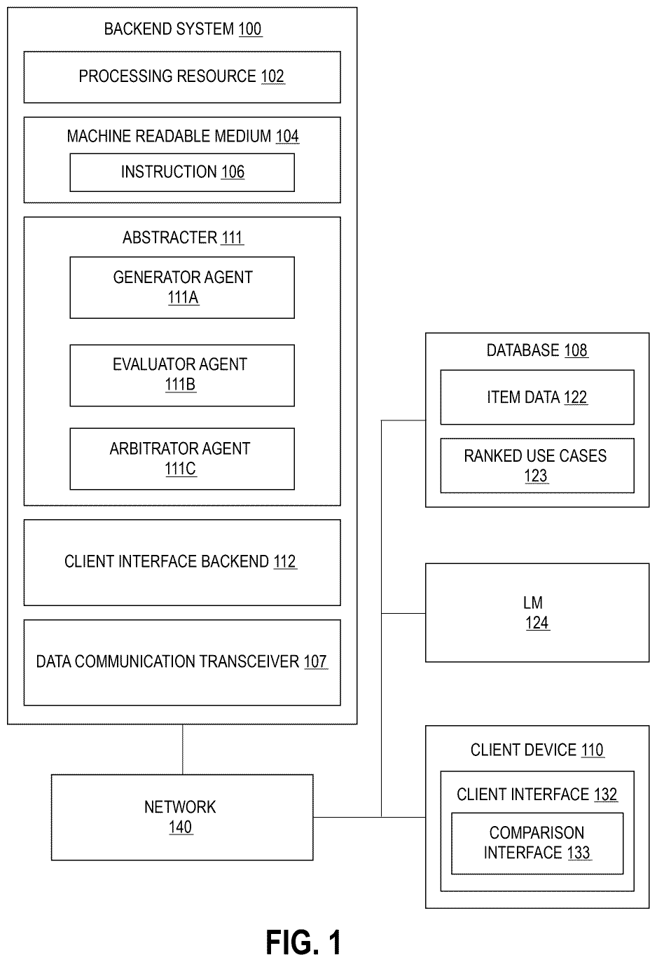

FIG. 1 illustrates a block diagram of an example metadata abstraction backend system 100 that utilizes one or more LMs (e.g., LLMs) to provide metadata abstraction. Language models (LMs) refer to a more general class of models varying in size but focused on conducting natural language tasks. Large language models (LLM) refer to specific types of LM known in the art that is trained on a large volume of data to generate outputs relating to language. As used herein, descriptions below referring to LM and LMs generally also may be LLM and LLMs.

The system 100 can include one or more electronic processing resources 102 that may include one or more microcontrollers, one or more microprocessors, one or more central processing unit cores, one or more application-specific integrated circuits (ASIC), one or more servers, one or more field programmable gate arrays (FPGA), control logic, other such systems or a combination of two or more of such systems. The system 100 further includes at least one machine readable medium 104 that may be non-transitory and include for example one or more random access memory (RAM), one or more read-only memory (ROM), one or more electrically erasable programmable read-only memory (EEPROM), one or more flash memory, one or more hard disk drives, other such mediums, or a combination of two or more of such mediums. Some or all of the medium 104 include one or more databases accessible via the network 140 that maintains and stores relevant data. Further, the medium 104 may be part of the processing resource, external to and accessible to the processing resource 102, or a combination of internal and external mediums. Additionally, one or more mediums may be remote and provide distributed and/or redundant storage. The one or more distributed networks 140 can be substantially any relevant wired and/or wireless computer and/or communications networks (one or more local area networks (LAN), one or more wireless area networks (WAN), one or more other wireless networks (e.g., cellular, Wi-Fi, Bluetooth, LoRa, LoRa-WAN, etc.), other such networks, or a combination of two or more of such networks).

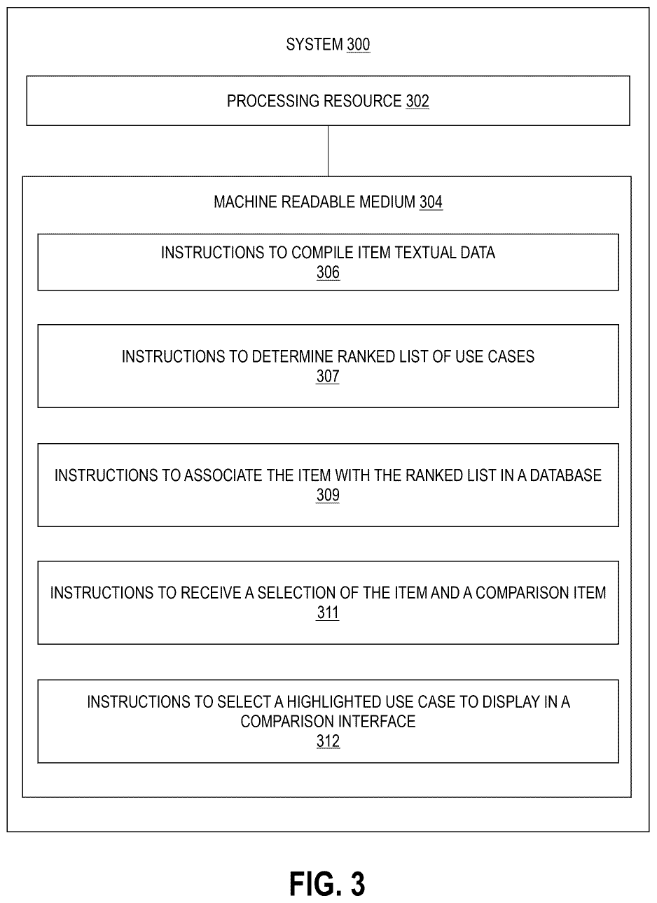

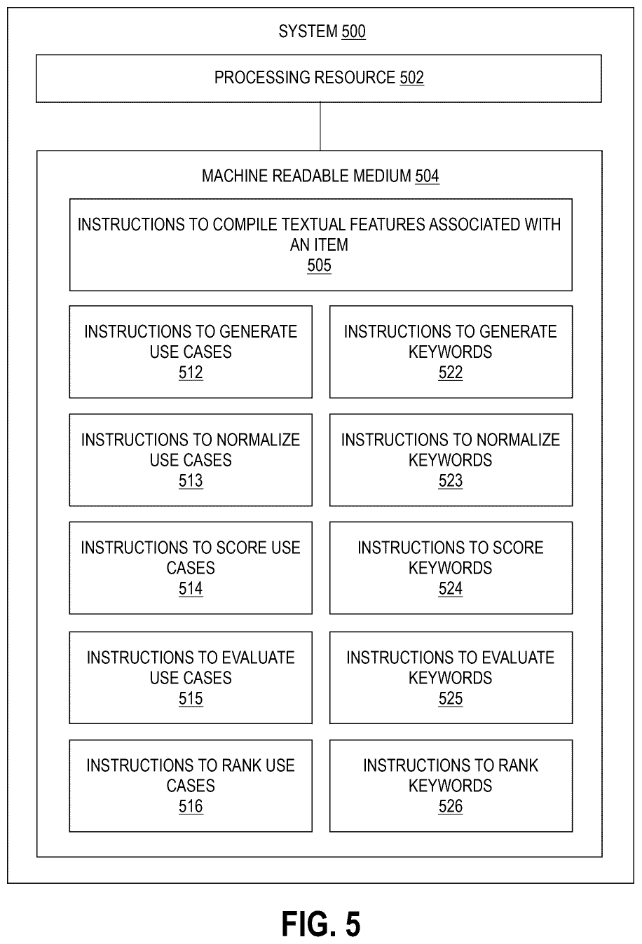

The processing resource 102 may execute instructions 106 (e.g., programming or software code) stored on machine readable medium 104 that when executed by processing resource 102 causes the processing resource to perform functions of the system 100. Additionally or alternatively, the processing resource 102 may include electronic circuitry for performing some or all of the functionality described herein. In particular, the processing resource 102 may execute instructions 106 (and/or utilize electronic circuitry) to implement an abstracter 111 and a client interface backend 112. Instructions 106 may include at least some of the instructions described below with reference to FIGS. 3 and 5.

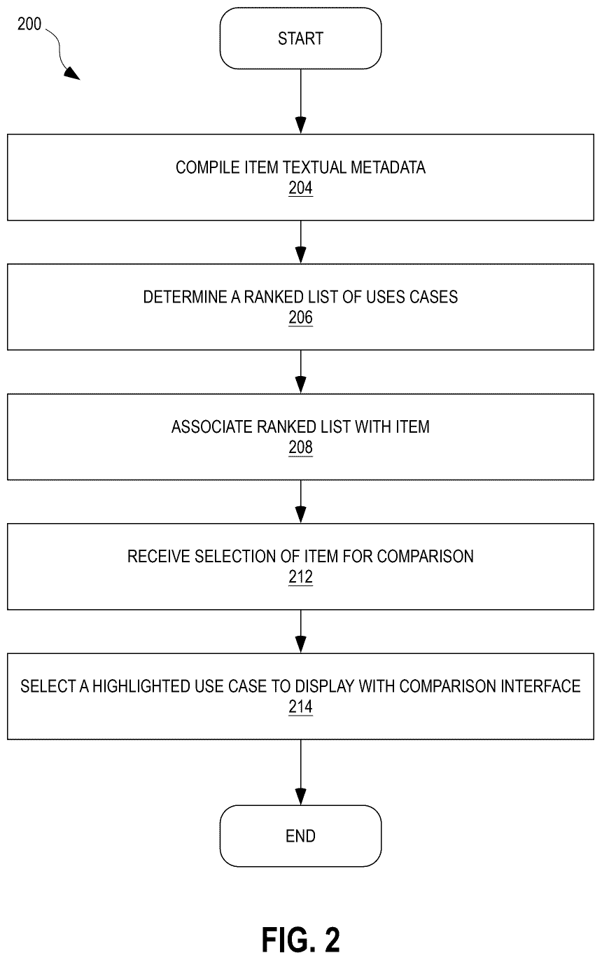

The abstracter 111 includes a plurality of LM agents each programmed to generate prompts for the LM 124 and process data received from the LM 124. In some embodiments, the agents may include an Application Programming Interface (API) for communicating with the LM 124. The generator agent 111A retrieves item data 122 from the database 108, extracts and compiles the metadata associated with the item, and prompts the LM 124 for metadata abstraction (e.g., item use cases). The evaluator agent 111B normalizes the abstractions and prompts the LM 124 to score the abstractions to determine a ranked list. The arbitrator agent 111C then verifies the abstractions in the ranked list against the item via the LM 124. While one LM 124 is generally described herein, in some embodiments, the abstracter 111 may include one or more agents that communicate with a plurality of different LMs 124. Further details of meta data abstraction systems and methods are described with reference to FIGS. 2-5 below.

In some embodiments, the LM agents described herein interface with the LM 124. In some embodiments, one or more LM agents may use rule-based programs or instruction sets programmed to make calls to the LM 124 and process the results. In some embodiments, one or more LM agents may be trained machine learning models. For example, these LM agents are model interface systems built on top of a machine learning model (e.g., a LM or a language sequence generation model) that may interact with external tools and application programming interfaces (APIs). A machine learning agent (e.g., an LM or a language sequence generation model) may further maintain a state and/or context across multiple steps by calling a machine learning model multiple times and recalling the input(s) and/or output(s) of each call. In some aspects, a machine learning agent (e.g., an LM or a language sequence generation model) may autonomously work toward specific goals. In other words, a machine learning agent (e.g., an LM or a language sequence generation model) utilizes machine learning models along with additional tools (e.g., open-source resources, search engines, additional models, etc.) in order to complete tasks.

The client interface backend 112 functions to provide data to support the display of the client interface 132 on the client device 110. For example, the client interface backend 112 may respond to data calls from the client device 110 based on data stored in the database 108. In some embodiments, the client interface backend 112 may determine and configure the data used to generate the client interface 132 on the client device 110 based on user inputs in the client interface 132 and data stored in the database 108. For example, client interface backend 112 may receive selections of items to include in the comparison interface 133, retrieve ranked use cases 123 associated with each of the items, select a highlighted use case from each selected item, and provide data for displaying the comparison interface 133, including the highlighted use cases, to the client device 110.

The system 100 may also include other hardware components, such as physical machine readable mediums or storage (e.g., hard disk drive, a solid state drive, or the like, or a plurality of such storage devices (e.g., an array of disks)), and may be locally attached (i.e., installed) in the system 100. In some implementations, physical storage may be accessed as a block storage device. The processing resource is communicatively coupled with and/or controls one or more wired and/or wireless data communications transceivers 107, transmitters and/or receivers that communicatively coupled with the one or more distributed communications networks 140. The processing resource 102 is communicatively coupled with the one or more transceivers 107 and control communicates from and/or to the processing resource and/or at least some communications from and/or to the system 100 to manage at least the response to queries, data distribution, retrieve information, and/or other such communications.

The backend system 100 includes and/or is in communication with one or more internal and/or external database 108 that can store data for use by the processing resource 102, other local systems and/or remote systems. Further, the databases may be part of the processing resource 102, the medium 104 and/or one or more separate mediums. The database 108 stores item data 122, which may include item metadata such as item name, item category, static retailer or seller item description, item specification, user reviews, professional reviews, and the like. In the e-commerce context, the item may be a product with a product identifier, and the metadata may include manufacturer/supplier data, marketing information, and user reviews gathered from one or more sites. The database 108 further stores ranked use cases 123 generated by the use case abstracter 111 executed by the backend system 100. The lists of ranked use cases 123 are associated with items in the item data 122. In some embodiments, the database 108 may further include lists of ranked use cases associated with product categories, subcategories, classes, and/or product lines.

The system 100 typically further includes and/or is accessible by numerous client devices 110 (e.g., computer, laptop, tablet, smartphone, user wearable system, etc.) that communicate with the backend system 100 to generate client interfaces 132 for display on a display device. The client interface 132 includes a comparison interface 133 that are partially generated based on the content of the ranked use cases 123 stored in the database 108. In some embodiments, the client interface 132 may be a website and/or a mobile application. In specific examples, the client interface 132 is an e-commerce interface that displays retail items through online, delivery, and/or physical store channels.

The system 100 also communicates with one or more LMs 124 via network 140. In some forms, it is contemplated that a single LM may be used to perform the operations described in this disclosure. In other forms, it is contemplated that multiple LMs may be used that may be implemented one after another in a series operation or that may be implemented at the same time in a parallel operation. In some embodiments, the one or more LMs 124 may be referred to as trained language models. In some embodiment, the one or more LMs 124 may be trained by third parties and residing and executed in a third party cloud server environment. In some embodiments, example LMs include: GPT-4 and ChatGPT from OpenAI; BERT, T5, Bard from Google; Claude 3.5; Llama from Meta, Bing Chat from Microsoft. In some embodiments, the one or more LMs 124 may be downloaded from third parties and trained using data specific to the system 100, and executed on server/s controlled by the system 100 developer.

FIG. 2 is a flow diagram of a process 200 that may be used to generate metadata abstraction for a comparison interface. The process 200 may be performed by a hardware processing resource, such as processing resource 102, described with reference to FIG. 1, executing a set of instructions, such as instruction 106, or by other processing resources.

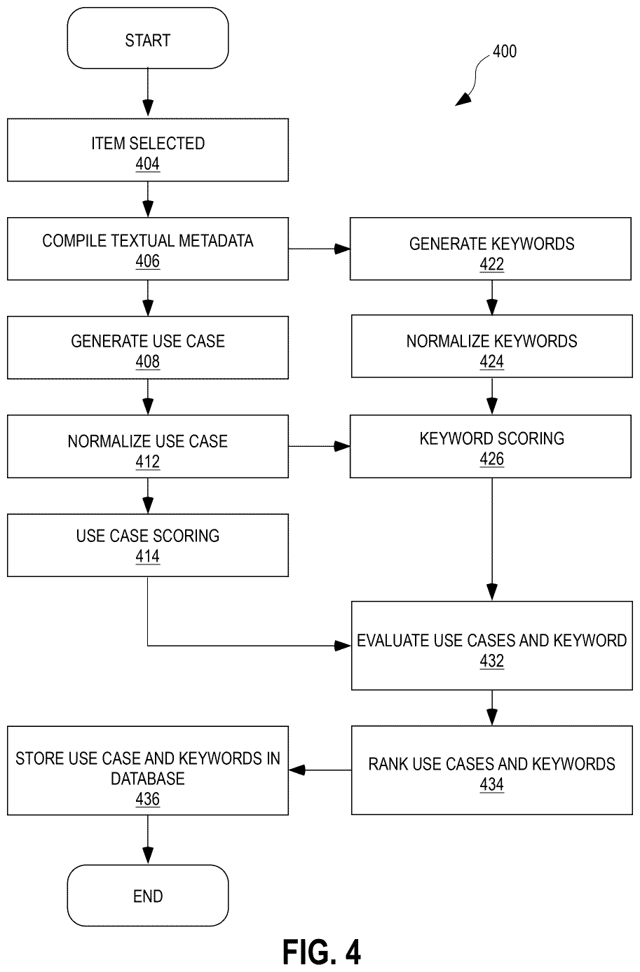

At step 204, textual metadata associated with an item is compiled from a database. In some embodiments, the textual metadata of the item is extracted from item description, item review, and/or item name. At step 206, a ranked list of use cases for the item is determined. The ranked list of the use cases is determined in part on sending one or more prompts to a language model, at least one of the one or more prompts includes the textual metadata. In some embodiments, the ranked list of use cases is determined based on a use case list output by the LM in response to a use case prompt including the textual metadata of the item. In some embodiments, the use case list output by the LM is normalized to a set of reference use cases prior to forming the ranked list. The use cases in the use case list are matched to reference use cases based on cosine similarity between embeddings of the use cases. The set of reference use cases may correspond to frequently occurring use cases for other items in a category associated with the item. In some embodiments, the ranked list of use cases is determined based on relevance scores associated with a plurality of use cases. The relevance scores may be determined using the LM with a relevance prompt that includes a use case and the textual metadata associated with the item. In some embodiments, the ranked list of use cases includes one or more backfilled use cases from use cases associated with a category of the item. For example, use cases for categories, subcategories, product classes, and/or product lines may be determined with similar methods using a LM. When an item does not have sufficient use cases with confidence and/or relevance scores exceeding a threshold, the use case list may be backfilled with use cases from the categories, subcategories, product classes, and/or product lines. In some embodiments, the abstracter may further determine keywords based on the items and the use cases. The keywords may be used to generate abstracted description/explanation for the associated use case. Further details of the determination of the ranked list of use cases and keywords are described with reference to FIGS. 4 and 5 herein.

Steps 204-208 may be repeated any number of times for items in a database before proceeding to step 212. In some embodiments, steps 204-208 may be repeated each time a new item is added to an item database. In some embodiments, steps 204-208 may be performed periodically for items without a stored use case list. In some embodiments, steps 204-208 and steps 212-214 may be asynchronous, meaning that steps 204-208 are performed before step 212 or any specific trigger from a client interface. The ranked lists use cases generated by steps 204-208 are stored/cached in a database, which reduces the latency of providing the comparison interface and allows for hard and software processing resources and LM queries/traffic to be shared by multiple client interfaces. That is, the stored ranked list of use cases for an item may be repeatedly used by multiple client interfaces on multiple client devices without further processing by the abstracter of the interface backend or further queries to an LM.

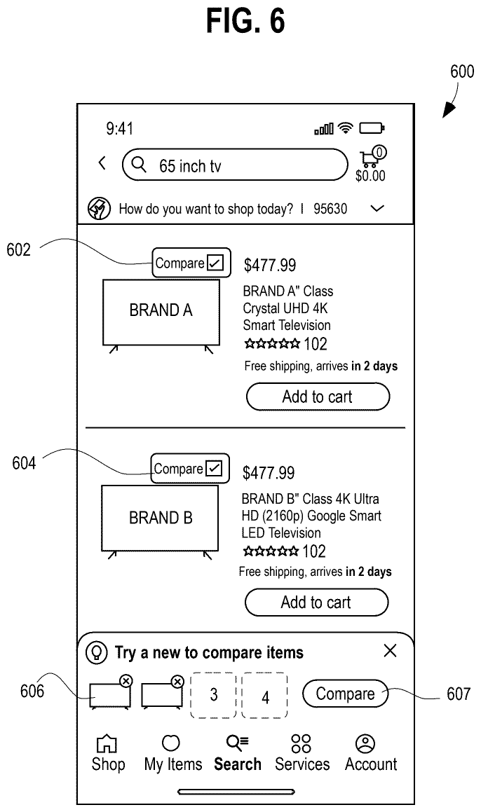

At step 212, a selection of the item and a comparison item is received via a client interface provided to a client device. FIG. 6 illustrates an example of a client interface for selecting items for comparison. In this example, the client interface 600 is an e-commerce site. The client interface 600 includes a list of items each with a checkbox 602, 604 that can be selected to add the respective item to a list of items for comparison 606. The list of items in the client interface 600 may be part of a search query or be a listing within a category or subcategory provided on the e-commerce site. In some embodiments, the list of items for comparison 606 may be maintained when the client navigates to different pages of the search result and/or category listing. Step 212 may be triggered when an icon 607 (i.e., “compare”) is selected. While the interface 600 includes four slots for items to be added for comparison, any number of items may be compared using the use cases determined in this process.

At step 214, a highlighted use case is selected to display with the item in a comparison interface. The highlighted use case is selected based on the ranked list associated with the item and a ranked list of use cases associated with the comparison item in the use case database. In some embodiments, the use case with the highest relevance score in the ranked list is selected as the highlighted use case for the item, unless the comparison item has the same use case with a higher relevance score, in which case, the use case with a second highest relevance score is selected as the highlighted use case for the item. This process may be iterated if the second use case is also chosen by the comparison item before the current item of interest to make sure all the compared items have diverse set of use cases. That is, if a use case is selected for multiple items based on the respectively ranked list of the items, the item with the highest relevance score is displayed with the use case as the item's highlighted use case. The other item(s) will continue down their respective use case list to select the next use case that is not shared by another item being compared.

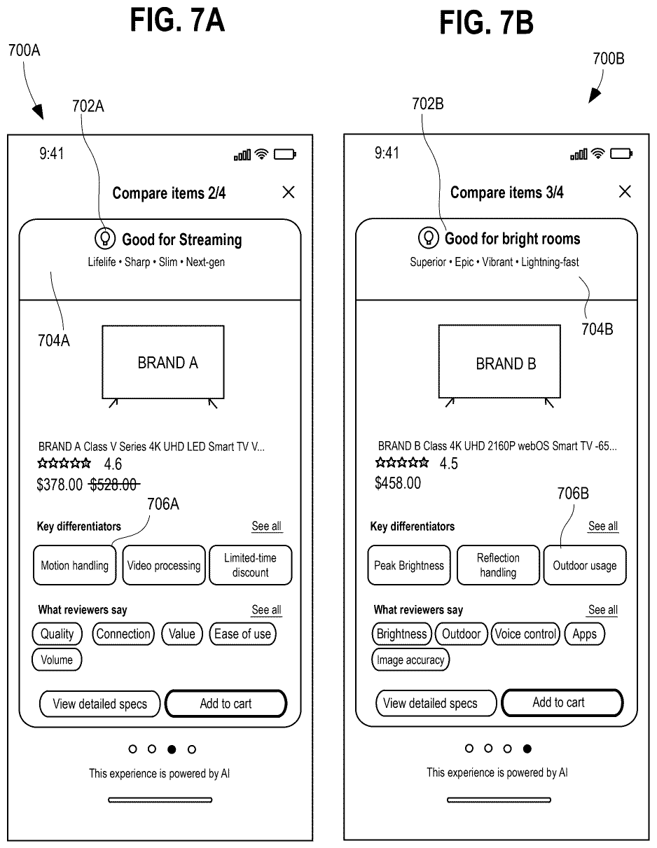

In some embodiments, the highlighted use case is evaluated for relevance to the item prior to being displayed in the client interface, and the relevance is evaluated via the language model using an evaluator prompt that includes the textual metadata of the item and the highlighted use case. In some embodiments, the evaluation may occur alternatively or additionally in step 208 for each use case in the ranked list prior to the ranked list being stored in the item database. FIG. 7A and FIG. 7B show example comparison interfaces according to some embodiments. In FIG. 7A, an item is displayed in a comparison interface 700A with the highlighted use case 702A of “good for streaming.” The use case abstraction differs from direct metadata comparison in that the abstraction considers item metadata/attributes holistically and provides an abstraction of a collective of attributes that can provide additional information and/or be more meaningful than any specific metadata/attribute on its own. In FIG. 7A, keywords 704A (“Life Like, Sharp, Slim, NextGen”) refers to key features, selling points, and attributes of the items. These are generated and sorted based on relevance to use case 702A (“good for streaming content”) to emphasize the key selling points of items and increase user engagement.

FIG. 7B a second item is displayed in a comparison interface 700B with the highlighted use case 702B of “good for gaming.” Keywords 704B (Superior, Epic, Vibrant, Lightning-fast) refers to key features, selling points, and attributes of the items. These are generated and sorted based on relevance to use case 702A (good for gaming) to emphasize the key selling points of items and increase user engagement. A user interface may display interfaces 700A and 700B side by side or in horizontally or vertically scrollable feature boxes.

FIG. 3 shows an example system 300 that includes non-transitory, machine readable media 304 (e.g., one or more machine readable mediums) that are encoded with example instructions executable by a processing resource 302. In some forms, the system 300 may be useful for implementing aspects of the system 100 of FIG. 1 or for performing aspects of process 200 of FIG. 2. For example, the instructions encoded on machine readable media 304 may be included in instructions 106 of FIG. 1. The processing resource 302 may include a microcontroller, a microprocessor, central processing unit core(s), an ASIC, an FPGA, and/or other hardware devices suitable for retrieval and/or execution of instructions from the machine readable media 304 to perform functions related to various examples. Additionally, or alternatively, the processing resource 302 may include or be coupled to electronic circuitry or dedicated logic for performing some or all of the functionality of the instructions described herein.

The machine readable media 304 may be of any medium suitable for storing executable instructions, such as RAM, ROM, EEPROM, flash memory, a hard disk drive, an optical disc, or the like. In some examples, the machine readable media 304 may be a tangible, non-transitory medium. The machine readable media 304 may be disposed within the system 300, in which case the executable instructions may be deemed installed or embedded on the system. Alternatively, the machine readable media 304 may be a portable (e.g., external) storage medium.

As described further herein below, the machine readable media 304 may be encoded with a set of executable instructions. It should be understood that part or all of the executable instructions and/or electronic circuits included within one box may, in alternate forms, be included in a different box shown in the figures or in a different box not shown. Some implementations may include more or fewer instructions than are shown in FIG. 3.

In FIG. 3, instructions may be used to perform metadata abstractions. Instructions 306, when executed, cause the processing resource 302 to compile, from a database, textual metadata associated with an item. Instructions 307, when executed, cause the processing resource 302 to determine a ranked list of use cases for the item based in part on using one or more prompts to a language model, at least one of the one or more prompts includes the textual metadata. Instructions 307, when executed, cause the processing resource 302 to associate the item with the ranked list of use cases in the database. In some embodiments, the ranked list of use cases is determined based on a use case list output by the LM (or a language scoring model) in response to a use case prompt including the textual metadata of the item. In some embodiments, the use case list output by the LM is normalized to a set of reference use cases prior to forming the ranked list. The use cases in the use case list are matched to reference use cases based on cosine similarity between embeddings of the use cases. The set of reference use cases may correspond to frequently occurring use cases for other items in a category associated with the item. In some embodiments, the ranked list of use cases is determined based on relevance scores associated with a plurality of use cases. The relevance scores may be determined using the LM (or a language model or a language scoring/evaluation model) with a relevance prompt that includes a use case and the textual metadata associated with the item. In some embodiments, the ranked list of use cases includes one or more backfilled use cases from use cases associated with a category of the item.

Instructions 309, when executed, cause the processing resource 302 to associate the item with the ranked list of use cases in the database. Instruction 311, when executed, cause the processing resource 302 to receive, via a client interface provided to a client device, a selection of the item and a comparison item. Instructions 312, when executed, cause the processing resource 302 to select a highlighted use case to display with the item in a comparison interface of the client interface. The highlighted use case is selected based on the ranked list associated with the item and a ranked list of use cases associated with the comparison item in the use case database.

FIG. 4 is a flow diagram of a process 400 that may be used to generate metadata abstraction for a comparison interface. The process 400 may be performed by a hardware processing resource, such as processing resource 102, described with reference to FIG. 1, executing a set of instructions, such as instruction 106 or other processing resources.

At step 404, an item is selected for metadata abstraction. In some embodiments, when new item is added to a database, a metadata abstraction may be performed to append abstraction data to the item data. In e-commerce, new products that have been transacted within a specific timeframe (last n days), but are not yet been assigned a ranked list of use cases may be selected and added to a list of item to be processed for use case abstraction.

At step 406, textual metadata of the item are compiled. Textual metadata may be extracted from item name, description, specification, and reviews. In some embodiments, textual metadata may be extracted from images of the product based on image recognition and visual feature exaction, such as by using a vision language model (VLM). The metadata are then used for both generating use cases and keywords.

At step 408, use cases are generated by making a call to a LM with a prompt that includes the item's textual metadata and receiving a list of use cases. For example, an LM agent may send the following prompt to an LM to generate use cases—
Consider the following product information: <product_data>
Usage Purposes Definition: Usage purposes refer to the specific intentions or functions for which
a product is designed, indicating its practical applications.
Your task is to generate at least <number_of_usecases> two-word usage purposes based on the
product's name, description and reviews. Each of these usage purposes should be able to
meaningfully complete the sentence: ‘These ‘productType’ are good for . . . ’
Your output should be formatted in JSON, capturing the usage purposes.
A sample JSON output format is:
{
“Usage Purposes”: [“purpose 1”, “purpose 2”, “purpose 3”, . . . ]

}

At step 412, use cases are normalized. The use cases output by the LM are mapped to a predefined list of use cases. In some embodiments, use cases in the use case list are matched to reference use cases based on cosine similarity between embeddings of the use cases. In some embodiments, the set of reference use cases corresponds to frequently occurring use cases for other items in a category associated with the item. In some embodiments, an agent may make another call to the embedding retrieval API to determine the embeddings associated with each use case and/or match each LM generated use case to a predefined use case.

At step 414, the normalized use cases are scored. An LM agent makes a call to the LM to request confidence scores indicating how relevant a use case is given the context that was part of the prompt used to generate the use case in step 408. For example, an LM agent may send the following prompt to an LM to generate use case relevance scores—
Consider the following product: \n ‘<word>’
Determine if the term ‘<word>’ is a relevant usage purpose for the product given its name and
description by checking how well the mentioned usage purpose completes the following sentence:
‘This product is good for . . . ’
Please output a confidence score between 0 and 1. This confidence score should show how well the
usage purpose is relevant to the item given the item information.
Your response is limited to JSON format only. A sample JSON output format is:
{

### “target Usage”: Confidence Score

}
Only Output the JSON. No Explanation Is Needed.

At step 422, keywords are generated. An LM agent makes a call to the LM to generate a list of keywords that would represent item characteristics with an prompt that includes the items'textual metadata. For example, an LM agent may send the following prompt to an LM to generate keywords—
Consider the following product: <product_data>
Your task is to output at least <number_of_keywords> one-word positive adjectives based on its Name and Description.
Your response should be in JSON format only. A sample JSON output format is:
{
“adjectives”: [“adjective 1”, “adjective 2”, “adjective 3”, . . . ]
}
Please Only Provide the Json Output. No Explanation Is Needed.

In some embodiments, step 422 also can be done with any sophisticated keywords generation machine learning model. In this case, the keywords generation model should be constructed from a sample of products and keywords.

At step 424, keywords are normalized. Keywords from the LM (e.g., LLM) in step 422 are standardized and simplified. The standardization may match the keywords to a predefined set of keywords while removing redundancies and meaningless keywords for the purpose of item comparison.

At step 426, keywords are scored for use cases from step 412. Confidence scores are assigned to keywords by making a call to an LM (e.g., LLM) using the keyword, the use case, and item data. The score indicates the keywords'relevance to the item and/or to a specific use case. For example, an LM agent may send the following prompt to an LM to score keywords—
Consider the usage of ‘<use_case>’ for a product in the category of ‘<productType>’.
How relevant is the following keyword to this usage: ‘<keyword>’?
Please output a confidence score between 0 and 1 showing the keyword's relevance to the usage.
Your response should be in JSON format only.
A sample JSON output format is:
{
“Target Confidence”: confidence score
}
Please only provide the JSON output. No explanation is needed.

In some embodiments, the keyword scoring can also be done through training a Natural Language Scoring model which takes the <Keyword>, <Use case>, and <productType> as input, and outputs a number score for relevance. In this case, this model is trained on a sample of [<Keyword>, <Use case>, and <productType> as well as <scores>] in order to get scores for unseen data.

At step 432, use cases and keywords are evaluated. An LM agent makes a call to the LM to determine whether the use cases from step 414 and keywords from step 426 are relevant to the item. Step 432 serves as a guardrail to, again, verify use case and keyword relevance against the item metadata being abstracted. In some embodiments, this verification may be performed based on the product's category or other specific attributes. For example, an LM agent may send the following prompt to an LM to verify a use case—
Consider the usage of ‘<use_case>’ for a product in the category of ‘<productType>’.
Is the following usecase ‘<use_case>’ relevant to the item?
Please output yes or no.
   In some embodiments, step 432 can also be done through training a Natural Language Scoring model which takes the <Use case>, <productType>, and <item data> as input, and outputs a number score for relevance. In this case, this model is trained on a sample of [<Keyword>, <item data >, and <productType>as well as <scores>] in order to get scores for unseen data.

At step 434, use cases that are verified in step 432 are ranked based on

use case scores from step 414. Keywords are also ranked for each use case based on use case specific keyword scores from step 426. At step 436 The ranked use cases and keywords are stored in a database, with a corresponding item identifier. In some embodiments, the ranked use cases and keywords may go through some post-processing prior to step 436. For example, keywords may be populated into templates or provided in a prompt to a LM to generate sentences of use case explanations prior to being stored in the database.

FIG. 5 shows an example system 300 that includes non-transitory, machine readable media 504 that are encoded with example instructions executable by a processing resource 502. In some forms, the system 500 may be useful for implementing aspects of the system 100 of FIG. 1 or for performing aspects of process 400 of FIG. 4. For example, the instructions encoded on machine readable media 504 may be included in instructions 106 of FIG. 1. The processing resource 502 may include a microcontroller, a microprocessor, central processing unit core(s), an ASIC, an FPGA, and/or other hardware device suitable for retrieval and/or execution of instructions from the machine readable media 504 to perform functions related to various examples. Additionally, or alternatively, the processing resource 502 may include or be coupled to electronic circuitry or dedicated logic for performing some or all of the functionality of the instructions described herein.

The machine readable media 504 may be of any medium suitable for storing executable instructions, such as RAM, ROM, EEPROM, flash memory, a hard disk drive, an optical disc, or the like. In some examples, the machine readable media 504 may be a tangible, non-transitory medium. The machine readable media 504 may be disposed within the system 500, in which case the executable instructions may be deemed installed or embedded on the system. Alternatively, the machine readable media 504 may be a portable (e.g., external) storage medium.

As described further herein below, the machine readable media 504 may be encoded with a set of executable instructions. It should be understood that part or all of the executable instructions and/or electronic circuits included within one box may, in alternate forms, be included in a different box shown in the figures or in a different box not shown. Some implementations may include more or fewer instructions than are shown in FIG. 5.

In FIG. 5, instructions may be used to perform metadata abstraction to generate ranked use cases and keywords. Instructions 505, when executed, cause the processing resource 502 to compile, textual metadata associated with an item. Instructions 512, when executed, cause the processing resource 502 to generate use cases via an LM agent sending a prompt for use cases to an LM. Instructions 513, when executed, cause the processing resource 502 to normalize the use cases output by an LM. Instructions 514, when executed, cause the processing resource 502 to score the normalized use cases via an LM agent sending a prompt for use case relevance scores to an LM. Instructions 515, when executed, cause the processing resource 502 to evaluate use cases via an LM agent sending a prompt to an LM to verify the relevance of each use case to the item. Instructions 516, when executed, cause the processing resource 502 to rank the verified use cases based on respective relevance scores.

Instructions 522, when executed, cause the processing resource 502 to generate keywords via an LM agent sending a prompt for use cases to an LLM (or any language model). Instructions 523, when executed, cause the processing resource 502 to normalize the keywords output by an LM. Instructions 524, when executed, cause the processing resource 502 to score the normalized keywords via an LM agent sending a prompt for keyword relevance scores to an LM (or a language scoring model). The relevance score may be specific to use cases. Instructions 525, when executed, cause the processing resource 502 to evaluate keywords via an LM agent sending a prompt to an LM to verify the relevance of each keyword to the item and use case. Instructions 526, when executed, cause the processing resource 502 to rank the verified keyword based on respective relevance scores.

Generally speaking, pursuant to various embodiments, systems, apparatuses, and methods are provided herein useful to metadata abstraction for a comparison interface. In some aspects, a system for meta data abstraction is provided. The includes a processing resource; and a non-transitory machine-readable medium storing instructions that, when executed by the processing resource, cause the processing resource to: compile, from a database, textual metadata associated with an item; determine a ranked list of use cases for the item based in part on using one or more prompts to a language model, at least one of the one or more prompts includes the textual metadata ; associate the item with the ranked list of use cases in the database; receive, via a client interface provided to a client device, a selection of the item and a comparison item; and select a highlighted use case to display with the item in a comparison interface of the client interface, wherein the highlighted use case is selected based on the ranked list associated with the item and a ranked list of use cases associated with the comparison item in the use case database.

In some aspects, the ranked list of use cases is determined based on a use case list output by the language model (e.g., LLM) in response to a use case prompt including the textual metadata of the item. In some aspects, the use case list is normalized to a set of reference use cases prior to forming the ranked list. In some aspects, the set of reference use cases corresponds to frequently occurring use cases for other items in a category associated with the item. In some aspects, use cases in the use case list are matched to reference use cases based on cosine similarity between embeddings of the use cases. In some aspects, the ranked list of use cases is determined based on relevance scores associated with a plurality of use cases. In some aspects, the relevance scores are determined using the language model (e.g., LLM) with a relevance prompt that includes a use case and the textual metadata associated with the item. In some aspects, the highlighted use case is evaluated for relevance to the item prior to being displayed in the client interface, and the relevance is evaluated via the language model (or another natural language evaluation/scoring model) using an evaluator prompt that includes the textual metadata of the item and the highlighted use case. In some aspects, the instructions when executed by the processing resource, cause the processing resource to further determine one or more keywords associated with characteristics of the item via the language model, and the comparison interface further displays at least one keyword associated with the item along with the highlighted use case. In some aspects, the one or more keywords are ranked for relevance for the highlighted use case, and the at least one keyword is selected based on a ranking of the one or more keywords. In some aspects, the one or more keywords are ranked based on relevance scores, wherein a relevance score for a keyword is determined via the language model (or another language scoring model) using a keyword ranking prompt, including item metadata, the highlighted use case, and the keyword. In some aspects, the ranked list of use cases includes one or more backfilled use cases from use cases associated with a category of the item. In some aspects, the textual metadata of the item is extracted from item description, item review, and/or item name. In some aspects, the use case with a highest relevance score in the ranked list is selected as the highlighted use case for the item, unless the comparison item has the same use case with a higher relevance score, in which case, the use case with a second highest relevance score is selected as the highlighted use case for the item. If the second highest relevance is also used by other comparison items, the use case with third highest relevance score is chosen.

In some aspects, a non-transitory machine-readable medium is provided. The non-transitory machine-readable medium stores instructions that, when executed by a processing resource, cause the processing resource to: compile, from a database, textual metadata associated with an item; determine a ranked list of use cases for the item based in part on using one or more prompts to a language model, (at least one of the one or more prompts includes the textual metadata ; associate the item with the ranked list of use cases in the database; receive, via a client interface provided to a client device, a selection of the item and a comparison item; and select a highlighted use case to display with the item in a comparison interface of the client interface, wherein the highlighted use case is selected based on the ranked list associated with the item and a ranked list of use cases associated with the comparison item in the use case database.

In some aspects, a method for providing a comparison interface in a client user interface is provided. The method includes: compiling, from a database, textual metadata associated with an item; determining a ranked list of use cases for the item based in part on using one or more prompts to a language model, at least one of the one or more prompts includes the textual metadata; associating the item with the ranked list of use cases in the database; receiving, via a client interface provided to a client device, a selection of the item and a comparison item; and selecting a highlighted use case to display with the item in a comparison interface of the client interface, wherein the highlighted use case is selected based on the ranked list associated with the item and a ranked list of use cases associated with the comparison item in the use case database. In some aspects, the ranked list of use cases is determined based on a use case list output by the language model in response to a use case prompt including the textual metadata of the item. In some aspects, the use case list is normalized to a set of reference use cases prior to forming the ranked list. In some aspects, the set of reference use cases corresponds to frequently occurring use cases for items in a category associated with the item. In some aspects, use cases in the use case list are matched to reference use cases based on cosine similarity between embeddings of the use cases.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system comprising:
a processing resource; and
a non-transitory machine-readable medium storing instructions that, when executed by the processing resource, cause the processing resource to:
compile, from a database, textual metadata associated with an item;
determine a ranked list of use cases for the item based in part on using one or more prompts to a language model, at least one of the one or more prompts includes the textual metadata;
associate the item with the ranked list of use cases in the database;
receive, via a client interface provided to a client device, a selection of the item and a comparison item; and
select a highlighted use case to display with the item in a comparison interface of the client interface, wherein the highlighted use case is selected based on the ranked list associated with the item and a ranked list of use cases associated with the comparison item in the use case database.

2. The system of claim 1, wherein the ranked list of use cases is determined based on a use case list output by the language model in response to a use case prompt including the textual metadata of the item.

3. The system of claim 2, wherein the use case list is normalized to a set of reference use cases prior to forming the ranked list.

4. The system of claim 3, wherein the set of reference use cases corresponds to frequently occurring use cases for other items in a category associated with the item.

5. The system of claim 3, wherein use cases in the use case list are matched to reference use cases based on cosine similarity between embeddings of the use cases.

6. The system of claim 1, wherein the ranked list of use cases is determined based on relevance scores associated with a plurality of use cases.

7. The system of claim 6, wherein the relevance scores are determined using the language model or a scoring model, with a relevance prompt that includes a use case and the textual metadata associated with the item.

8. The system of claim 1, wherein the highlighted use case is evaluated for relevance to the item prior to being displayed in the client interface, and the relevance is evaluated via the language model or a scoring model using an evaluator prompt that includes the textual metadata of the item and the highlighted use case.

9. The system of claim 1, wherein the instructions when executed by the processing resource, cause the processing resource to further determine one or more keywords associated with characteristics of the item via the language model, and the comparison interface further displays at least one keyword associated with the item along with the highlighted use case.

10. The system of claim 9, wherein the one or more keywords are ranked for relevance for the highlighted use case, and the at least one keyword is selected based on a ranking of the one or more keywords.

11. The system of claim 10, wherein the one or more keywords are ranked based on relevance scores, wherein a relevance score for a keyword is determined via the language model using a keyword ranking prompt, including item metadata, the highlighted use case, and the keyword.

12. The system of claim 1, wherein the ranked list of use cases includes one or more backfilled use cases from use cases associated with a category of the item.

13. The system of claim 1, wherein the textual metadata of the item is extracted from item's retailer description, seller description, item review, and/or item name.

14. The system of claim 1, wherein the use case with a highest relevance score in the ranked list is selected as the highlighted use case for the item, unless the comparison item has the same use case with a higher relevance score, in which case, the use case with a second highest relevance score is selected as the highlighted use case for the item.

15. A non-transitory machine-readable medium storing instructions that, when executed by a processing resource, cause the processing resource to:
compile, from a database, textual metadata associated with an item;
determine a ranked list of use cases for the item based in part on using one or more prompts to a language model, at least one of the one or more prompts includes the textual metadata;
associate the item with the ranked list of use cases in the database;
receive, via a client interface provided to a client device, a selection of the item and a comparison item; and
select a highlighted use case to display with the item in a comparison interface of the client interface, wherein the highlighted use case is selected based on the ranked list associated with the item and a ranked list of use cases associated with the comparison item in the use case database.

16. The medium of claim 15, wherein the ranked list of use cases is determined based on a use case list output by the language model in response to a use case prompt including the textual metadata of the item; and
wherein the use case list is normalized to a set of reference use cases prior to forming the ranked list.

17. A method for providing a comparison interface in a client user interface, the method comprises:
compiling, from a database, textual metadata associated with an item;
determining a ranked list of use cases for the item based in part on using one or more prompts to a language model, at least one of the one or more prompts includes the textual metadata;
associating the item with the ranked list of use cases in the database;
receiving, via a client interface provided to a client device, a selection of the item and a comparison item; and
selecting a highlighted use case to display with the item in a comparison interface of the client interface, wherein the highlighted use case is selected based on the ranked list associated with the item and a ranked list of use cases associated with the comparison item in the use case database.

18. The method of claim 17, wherein the ranked list of use cases is determined based on a sorted use case list output by the language model in response to a use case prompt including the textual metadata of the item; and
wherein the use case list is normalized to a set of reference use cases prior to forming the ranked list.

19. The method of claim 18, wherein the set of reference use cases corresponds to frequently occurring use cases for items in a category associated with the item.

20. The method of claim 18, wherein use cases in the use case list are matched to reference use cases based on cosine similarity between embeddings of the use cases.
